(19) United States
(12) Patent Application Publication
(10) Pub. No.: US 2003/0111645 A1
(43) Pub. Date: Jun. 19, 2003

(54) Coolant system treatment tablet

(76) Inventors: William R. Kughn, Granite Bay, CA (US); Edward R. Eaton, Phoenix, AZ (US)

Correspondence Address: JOHNSON & STAINBROOK, LLP, Suite 203, 3550 Round Barn Blvd., Santa Rosa, CA, 95403, US

(21) Appl. No.: 10/051,797

(22) Filed: Oct. 19, 2001

Related U.S. Application Data
(60) Provisional application No. 60/242,119, filed on Oct. 19, 2000.

(51) Int. Cl. B01F 3/00

(52) U.S. Cl. 252/363.5

(57) ABSTRACT

A solid, water-soluble coolant system treatment tablet for addition to the overflow cannister of an engine coolant system. The tablets are pressed solid cakes including a scale and deposition preventative, a pH buffer, a chemical inhibitor, at least one corrosion preventative, and a binder. The inventive tablets include sodium tetraborate, sodium meta silicate, sodium nitrate, sodium MBT, and for diesel engine use, sodium nitrite.

### CROSS REFERENCE TO RELATED APPLICATIONS

The present application claims the benefit of the filing date of U.S. Provisional Patent Application Serial No. 60/242,119, filed Oct. 19, 2000.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to engine coolant system additives, and more particularly to a solid, water-soluble tablet for dispensing in an internal combustion engine coolant system for maintaining optimum chemical inhibitor levels.

### BACKGROUND INFORMATION AND DISCUSSION OF RELATED ART

Conventional gasoline and diesel internal combustion engines generally employ water-based cooling systems. This is primarily due to the superior heat exchange properties of water and its universal availability. However, particularly in regions with hard water, coolant system water can cause mineral and chemical deposition and scaling on cooling system interior surfaces, and the accretions can eventually lead to clogs. Thus, it has long been known that the long-term efficiency of a cooling system for an internal combustion engine mandates the inclusion of cleaning and chemical inhibiting compositions into the water-based cooling system fluids. The cleaning ingredients ostensibly prevent the accretion of scale and other depositions on the interior surfaces of the cooling system, and the chemical inhibitors reduce the corrosiveness of the coolant liquids. The coolants are also designed to resist freezing and boiling, generally through the inclusion of aqueous ethylene glycol or aqueous propylene glycol having a glycol concentration of roughly 40 ivy to 70%. This method has been employed extensively for decades.

Coolants and antifreeze are routinely introduced into engine cooling systems by combining commercially manufactured concentrated or pre-diluted solutions and either pouring or pumping the solution into the system. Over time some components of coolant degrade, loose their inhibitory properties, and require recharging. Some automotive systems, and nearly all heavy duty coolant mixtures, require a periodic supplemental charging of the chemicals to maintain optimum (or even effective) chemical inhibitors in the mixture. Several methods have been employed to introduce supplemental chemistry into the cooling system. At present the methods most commonly used to introduce the chemicals into the depleted cooling system include:

(1) “Liquid Add Systems,” wherein chemistry is added by introducing into the system a liquid containing the chemistry.

(2) Filter Dispensing Systems, wherein chemistry is introduced by installing a coolant filter that dispenses the chemical during engine operation.

The “liquid add” systems typically work in a satisfactory manner provided that the technician first checks the capacity of the cooling system to determine the proper proportions for the amount of liquid to be introduced. Maintaining a cooling system with this method exposes the system to errors in implementation, and thus to over-inhibiting or under-inhibiting the system chemistry. The coolant filter method requires that a costly physical device be installed, requiring both a capital expenditure and the costs for the installation. In both instances testing of the installed coolant must be done to determine the amount and necessity of chemical additives.

Exemplary of the art among liquid add compositions, U.S. Pat. No. 4,711,735 to Gulley Teaches a the coolant additive designed to avoid the use of silicates which form deposits that coat the surfaces and passageways of heavy duty diesel and other cooling, systems. The additive includes Sodium hydroxide and/or alkyl metal carbonate, ricinoleic acid, Reomet 41, Thiotax, various forms of SMA copolymers, sodium benzoate, sodium nitrate, chelant(s), antifoam agents, dye/pH indicator and soft water (composition solvent), mixed together in predetermined proportions with the additive including other constituent substances.

U.S. Pat. No. 5,711,894 to Miyake, et al. discloses an antifreeze concentrate that includes at least one ingredient selected from the group consisting of alkoxybenzoic acids and their-amine salts. alkali metal salts and ammonium salts, wherein “R” is an alkyl group of carbon number 1-5. The coolant concentrate and antifreeze concentrate include the additive in the range of about 0.05-8.0wt. %.

Illustrative of filter-specific compositions is disclosed in U.S. Pat. No. 4.980,075 to Dobrez, et al. which teaches an improved coolant fill composition for use in a coolant system filter having a space into which a supplemental coolant additive can be placed, wherein the supplemental coolant is automatically introduced into the space in the form of a liquid-powdered solids slurry.

Finally, illustrative of the filter dispensing systems is U.S. Pat. No. 5,948,248 to Brown, which discloses a diesel engine coolant filter apparatus which itself includes a supplemental coolant additive cartridge for delayed release of chemical additives into the coolant being filtered. The apparatus provides a spin-on canister type coolant filter which combines the functions of filtering the coolant of the diesel engine cooling system with the function of adding supplemental coolant additives to the coolant to reduce or eliminate the effects of cavitation erosion caused by vibration of the cylinder liners of the diesel engine. The filter includes a chemical additive cartridge mounted within an outer shell and a filter cartridge mounted about the chemical additive cartridge and inside the outer shell. Coolant to be filtered passes by the chemical additive cartridge, which slowly releases the chemical additive into the passing coolant stream. The coolant containing the chemical additive then passes through the filter to remove relatively large pieces of the chemical additive as well as other debris before exiting the filter for subsequent cooling of the diesel engine. In order to slowly release the chemical additive, the chemical cartridge includes relatively small air vents and outlets and the filter outlet includes a restriction orifice which further slows the release of the chemical additive into the coolant stream.

While the known coolant additives and coolant additive systems have demonstrated commercial viability, they suffer one or more significant shortcomings, including:

reliance on a technician's determination of the need for chemistry;

the potential of over and/or under inhibiting by both methods;

labor costs associated with both methods.

### BRIEF SUMMARY OF THE INVENTION

Accordingly, a convenient and easy to use coolant system treatment tablet is provided for recharging the chemical inhibitor package of an internal combustion cooling system. The inventive treatment tablet is most generally characterized as a solid, water-soluble tablet for addition to the fluids of an engine coolant system, said tablet comprising a scale and deposition preventative, a pH buffer, a chemical inhibitor, at least one corrosion preventative, and a binder. The composition preferably comprises sodium tetraborate, sodium meta silicate, sodium nitrate, and sodium MBT. Sodium nitrite may be added to inhibit cavitation of diesel engine cylinder linings.

For use in diesel engines, the tablet comprises, by weight based on dry composition, 0.45 percent sodium tetraborate, 0.03 percent sodium meta silicate, 0.31 percent sodium nitrite, 0.09 percent sodium nitrate, and 0.12 sodium MBT. For use in gasoline internal combustion engines, sodium benzoate may be included in an amount up to about 0.20 percent. For universal application, the tablet preferably includes 0.41 pepercent sodium tetraborate, 0.11 percent sodium meta silicate, 0.19 percent sodium nitrite, 0.08 percent sodium nitrate, 0.11 percent sodium MBT, and 0.09 percent sodium benzoate.

### DETAILED DESCRIPTION OF THE INVENTION

According to the present invention there is provided an engine coolant system treatment tablet and a method of using the same to dispense chemical inhibitors into engine cooling systems. When added to an engine cooling system, the inventive composition inhibits oxidation of ethylene glycol and/or propylene glycol and reduces corrosion, deposition, and scale accretion on coolant system interior surfaces. The invention improves over existing technology by providing a more efficient, safer, less labor intensive, and more concise dosage method than is provided by any current methods. It is also well suited as an additive for newly emerging extended life coolants having carboxylic inhibitor packages.

In one aspect, the inventive composition is characterized as a solid, water-soluble coolant system treatment tablet for addition to the coolant of an engine coolant system, comprising, by weight based on dry composition, from about 0.36 to about 0.50 percent sodium tetraborate, up to 0.20 percent sodium meta silicate, from about 0.04 to about 0.20 percent sodium nitrate, and from about 0.05 to 0.20 percent sodium MBT. If it is desired to inhibit or prevent cavitation of diesel engine cylinder linings, sodium nitrite may be added in an amount ranging from about 0.08 to about 0.30 percent.

Several formulations of the inventive tablet have been devised through experimentation and have been demonstrated to be particularly effective for certain fields of use. For example, when the tablet is to be used as an engine coolant system additive for heavy duty diesel engines, the tablet comprises, by weight based on dry composition, 0.45 percent sodium tetraborate, 0.03 percent sodium meta silicate, 0.31 percent sodium nitrite, 0.09 percent sodium nitrate, and 0.12 sodium MBT.

For use in conventional internal combustion engines, sodium benzoate may be included, as it is particularly stable, durable and long-lived, and is an effective corrosion preventative for aluminum and ferrous metals. Accordingly, it may be desirable to up to about 0.20 percent sodium benzoate. The preferred formulation of the inventive tablet for universal and general application includes, by weight based on dry composition, 0.41 percent sodium tetraborate, 0.11 percent sodium meta silicate, 0.19 percent sodium nitrite, 0.08 percent sodium nitrate, 0.11 percent sodium MBT, and 0.09 percent sodium benzoate.

In another aspect, and in the most general terms, the inventive treatment tablet may be characterized as a solid, water-soluble tablet for addition to the fluids of an engine coolant system, said tablet comprising a scale and deposition preventative, a pH buffer, a chemical inhibitor, at least one corrosion preventative, and a binder. This characterization highlights a unique feature of the present invention: it is embodied as a discrete article comprising solid constituents pressed into a small solid cake, or tablet, which can easily be dropped into a coolant system whole. This greatly reduces the costs of manufacturing, packaging, and shipping, as the great bulk of the size and weight of engine coolants is in the water added to the active ingredients, not the active ingredients themselves. As will be readily appreciated, the inventive tablet can be shrink wrapped, boxed, and shipped, and stored in relatively small and lightweight packages. The tablet eliminates the step of placing activingredient in aqueous solution before the ingredients are placed in solution a coolant system. End users can keep a small amount in storage in the car to effect coolant system recharging without the need of carrying a large container of liquid coolant.

The tablet may include a buffer, which is preferably either a phosphate, and more preferably di-potassium phosphate, or sodium tetraborate. The buffer is preferably in an amount, by weight based on dry composition, of 0.01 to 0.50 percent. When di-potassium phosphate is used, it is optimally in an amount of up to about 0.30 percent, by weight based on dry composition. When sodium tetraborate is used, it is optimally included in amount of between 0.36 to 0.50 percent.

In use in diesel engines, the tablet preferably includes a cavitation preventative, the preferred component being sodium nitrite in an amount, by weight based on dry composition, of 0.08 to 0.50 percent.

Numerous corrosion preventatives can be included in the inventive tablet, including sodium meta silicate for aluminum protection, sodium nitrate for general ferrous metal corrosion inhibition, sodium MBT to prevent rusting of copper and brass, and sodium benzoate, a long-lived general corrosion preventative particularly effective for aluminum and ferrous metals.

The tablet preferably employs a binder selected from the group consisting of sodium MBT and sodium tolyltriazole. Because of its superior binding properties, sodium MBT is the preferred binder.

Finally, the inventive treatment tablet may be formulated specifically for addition to an engine coolant system employing extended life coolants having carboxylic chemical inhibitor ingredients. This formula preferably includes, by weight based on dry composition, up to 0.50 percent sodium benzoate, up to 0.30 percent sodium nitrate; and from 0.05 to 0.50 percent binder and corrosion preventative selected from the group consisting of sodium MBT and sodium tolyltriazole. The most effective formulation tested to date comprises sodium benzoate in the amount of 0.39 percent, sodium nitrate in the amount of 0.22 percent, and binder and corrosion preventative in the amount of 0.39 percent, though slight variations in these quantities will only nominally affect the tablet's effectiveness.

The method of using the inventive coolant capsule or tablet entails three simple steps: first, providing at least one of the above-described coolant system treatment capsules; second, determining the cooling system capacity; and third, simply inserting the required number of “coolant tablets” into the cooling system overflow canister. As the tablet(s) dissolves, the chemistry is dispersed into the liquid of the cooling system. The tablet contains the correct amount of chemistry for a specific number of gallons of coolant. The number of tablets required is determined by the total cooling system capacity of the cooling system into which it is introduced. The tablet is safer to handle than conventional liquids, as conventional liquids risk spill potential and splash potential for the technician. The filter method requires safe and correct environmental disposal of the physical canister.

While this invention has been described in connection with preferred embodiments thereof, it is obvious that modifications and changes therein may be made by those skilled in the art to which it pertains without departing from the spirit and scope of the invention. Accordingly, the scope of this invention is to be limited only by the appended claims.

What is claimed as invention is:

1. A solid, water-soluble coolant system treatment tablet for addition to the coolant of an engine coolant system, said tablet comprising, by weight based on dry composition:
from 0.36 to 0.50 percent sodium tetraborate;
from 0.00 to 0.20 percent sodium meta silicate;
from 0.04 to 0.20 percent sodium nitrate; and
from 0.05 to 0.20 percent sodium MBT.

2. The coolant system treatment tablet of claim 1, further including: from 0.08 to 0.30 percent sodium nitrite.

3. The coolant system treatment tablet of claim 1, wherein said table comprises, by weight based on dry composition:
0.45 percent sodium tetraborate;
0.03 percent sodium meta silicate;
0.31 percent sodium nitrite;
0.09 percent sodium nitrate; and
0.12 sodium MBT.

4. The coolant system treatment tablet of claim 1, further including:
from 0.00 to 0.20 percent sodium benzoate.

5. The coolant system treatment tablet of claim 1, further including sodium molybdate in an amount of 0.00 to 0.15 percent, by weight based on dry composition.

6. The coolant system treatment tablet of claim 4, wherein said tablet comprises, by weight based on dry composition:
0.41 percent sodium tetraborate;
0.11 percent sodium meta silicate;
0.19 percent sodium nitrite;
0.08 percent sodium nitrate;
0.11 percent sodium MBT; and
0.09 percent sodium benzoate.

7. A solid, water-soluble tablet for addition to the fluids of an engine coolant system, said tablet comprising a scale and deposition preventative, a pH buffer, a chemical inhibitor, at least one corrosion preventative, and a binder.

8. The tablet of claim 7, wherein said buffer is selected from the group consisting of di-potassium phosphate and sodium tetraborate.

9. The tablet of claim 8, wherein said buffer is in an amount, by weight based on dry composition, of 0.01 to 0.50 percent.

10. The tablet of claim 7, further including a cavitation preventative.

11. The tablet of claim 10, wherein said cavitation preventative is sodium nitrite in an amount, by weight based on dry composition, of 0.08 to 0.50 percent.

12. The tablet of claim 7, wherein said corrosion preventative is selected from the group consisting of sodium meta silicate, sodium nitrate, sodium MBT, sodium benzoate, sodium molybdate, and combinations thereof.

13. The tablet of claim 12, wherein said corrosion preventative includes, by weight based on dry composition:
from 0.00 to 0.20 percent sodium meta silicate;
from 0.04 to 0.20 percent sodium nitrate; and
from 0.05 to 0.20 percent sodium MBT.

14. The tablet of claim 13, further including, by weight based on dry composition, from 0.01 to 0.20 percent sodium benzoate.

15. The tablet of claim 7, wherein said binder is selected from the group consisting of sodium MBT and sodium tolyltriazole.

16. The tablet of claim 15, wherein said binder is in an amount, by weight based on dry composition, of 0.05 to 0.50 percent.

17. A solid, water-soluble coolant system treatment tablet for addition to an engine coolant system employing extended life coolants having carboxylic chemical inhibitor ingredients, said tablet comprising, by weight based on dry composition:
from 0.00 to 0.50 percent sodium benzoate;
from 0.00 to 0.30 percent sodium nitrate; and
from 0.05 to 0.50 percent binder and corrosion preventative selected from the group consisting of sodium MBT.and sodium tolyltriazole.

18. The tablet of claim 17, wherein said sodium benzoate is in an amount, by weight based on dry composition, of 0.39 percent, said sodium nitrate is in an amount, by weight based on dry composition, of 0.22 percent, and said binder and corrosion preventative is in an amount, by weight based on dry composition, of 0.39 percent.

19. A method of recharging the chemical inhibitor package in an internal combustion engine coolant system having an overflow canister, comprising the steps of:
(a) providing a plurality of the coolant system treatment tablets of any one of claims 1 through 18, inclusive;
(b) determining the cooling system capacity; and
(c) inserting at least one coolant system treatment tablet into the cooling system overflow canister according to the amount required for the cooling system capacity.
